(19) United States
(12) Patent Application Publication
(10) Pub. No.: US 2007/0218445 A1
(43) Pub. Date: Sep. 20, 2007

(54) COMPUTER BASED BLACKBOARD

(75) Inventor: Ted Osaosere Uwague-Igharo, Mastic Beach, NY (US)

Correspondence Address: Mr.Ted Osaosere Uwague-Igharo, 27 Market Street, Mastic Beach, NY, 11951, US

(73) Assignee: Ted Osaosere Uwague-Igharo, Mastic Beach, NY (US)

(21) Appl. No.: 11/308,268

(22) Filed: Mar. 14, 2006

(51) Int. Cl. G06F 9/00

(52) U.S. Cl. 434/322; 715/764; 715/700

(57) ABSTRACT

A method of and a system for creating a Computer-based Blackboard, the method allow for the input of text, and symbols in an input field, modifying the text attributes and displaying the data in a display form for use with a variety of types of information processing and display; ranging from online tutoring to text content creation.

### CROSS-REFERENCE TO RELATED APPLICATIONS

U.S. Pat. No. 6,611,822 (Beams, et. al., 2003) describes a system that includes rule-based expert training to provide educational knowledge. The system provides the user with a simulated environment that presents a training opportunity to understand and solve problems optimally. The system provides for “online classrooms” with application sharing, whiteboard, and discussion activities.

U.S. Pat. No. 6,341,960 (Frasson, et. al., 2002) describes a method and apparatus for agent-based automated delivery of tutoring.

Reference: Microsoft User manual

### BACKGROUND

The present invention relates to computer-based data creation and editing in general, and more specifically to methods for creating documents for display.

One of the most important tools used by educators is the blackboard. Using a chalk or colored pencil, tutors and teachers can present information to their students in clearly legible writing. With the advent of online tutoring and distance learning, most editors for use with respect to science subjects require a learning curve and lack the robustness and simplicity needed for use in a time constraint virtual online classroom.

Most students in high schools, colleges and university turn in science assignment and homework on a piece of paper because of the difficulty involve in using current text editor to write the applicable equations and symbols.

Half the time tutors spent checking the solutions to turn in homework and assignments by their students is on deciphering illegible hand writing.

### BRIEF DESCRIPTION OF THE INVENTION

In light of the above, a need exists for a computer based blackboard for science subjects.

Accordingly, one embodiment of the invention provides a method for online tutors to effectively display, create and edit real time information for their students, while can use current this technology to produce legible and editable solutions to their homework assignment in a timely manner. The first device is a viewer for displaying the data content sent from the second device in near real time. The second device is a graphical interface that allows users to input text and graphically represented symbols with the selection of a mouse. The second device also allow for operations such as editing current data, saving and opening other text documents.

### SUMMARY

A method for creating a computer-based blackboard for creating and displaying document containing text, and symbols by allowing input of data, editing such data, saving such data and retrieving saved data.

A system for creating a computer-based blackboard for creating and displaying document containing text, and symbols for online web tutoring.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows graphical presentation of a blank graphical text accordance to an embodiment of the present disclosure;

FIG. 2 shows graphical presentation of a blank display form in accordance to an embodiment of the present disclosure;

FIG. 3 shows a flowchart illustrating an embodiment of the present disclosure;

FIG. 4 shows schematically the steps whereby data is inputted into the graphical editor using a keyboard in accordance to an embodiment of the present disclosure;

FIG. 5 shows schematically the steps whereby data is inputted into the graphical editor using a mouse in accordance to an embodiment of the present disclosure;

FIG. 6 shows schematically the step whereby symbol components are inserted into the graphical editor using a mouse in accordance to an embodiment of the present disclosure;

FIG. 7 shows a sample graphical editor form created in accordance to an embodiment of the present disclosure on a data processing apparatus, e.g. a computer;

FIG. 8 shows a sample display form created in accordance to an embodiment of the present disclosure on a data processing apparatus, e.g. a computer;

FIG. 9 shows a list of actions which can be performed on the graphical editor in accordance to an embodiment of the present disclosure;

FIG. 10 shows a list of Standard ASCII symbols which can be inserted on the graphical editor in accordance to an embodiment of the present disclosure;

FIG. 11 shows a list of Non-Standard mathematical symbols which can be inserted on the graphical editor in accordance to an embodiment of the present disclosure;

FIG. 12 shows graphical display of both the graphical editor and the display as used in an Application sharing mode in accordance to an embodiment of the present disclosure;

FIG. 13 shows graphical display of both the graphical editor and the display as used in an online tutoring session created in accordance to an embodiment of the present disclosure;

### DETAILED DESCRIPTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

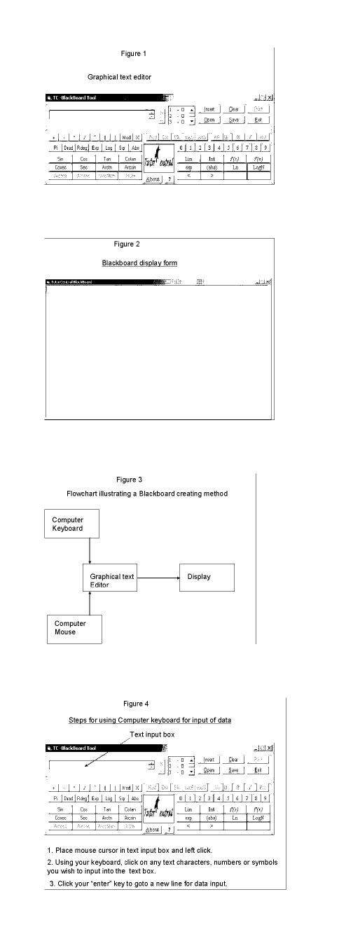

FIG. 1 is a diagram showing the graphical text editor on a data processing apparatus, e.g. computer according to an embodiment of the invention. The graphical text editor used in the following description is selected merely for simplifying the description of the invention. Thus, the invention is not limited to such an environment as a matter of course.

The present embodiment of the invention show that by using your keyboard or simply clicking with the mouse on a button with icon corresponding to the type of information or text you desire, elements of text or symbols can be inserted into the text input box.

The present embodiment of the invention shows that by using the scroll menu on your text input box, you may move to previously written sections or inputted text and data and modify the content. The old data is simply deleted in memory and written over.

The present embodiment of the invention show that the graphical text editor may contain not only the input field but also ASCII symbols and pre-defined symbols and by virtue of such a object, a user may:

In addition, by virtue of such a method user may add new symbols to existing symbol to be stored on user computer.

Open previously saved text file format.

Create new blank document.

Save current session in popular formats such as text, html, Xml and MathML;
the user is allowed to select a single text or a series of text in the text input box and modify its attributes, such as change it color, size and script;
the user can add Images;

FIG. 2 is a diagram showing the display form on a data processing apparatus, e.g. computer according to an embodiment of the invention. The display form used in the following description is selected merely for simplifying the description of the invention.

The display window is a simple single graphical text display board which accepts input information from the graphical text editor with the entire attributes of each message intact without modification. For example, a bold text inputted into the Graphical text editor with is displayed as a corresponding bold text on the display.

When the present invention assigns a refresh rate based on the computer system clock to the graphical text editor, it is envisaged that the data displayed on the display form is updated at that rate. For example, according to the embodiment of the invention when a text or information is inputted into the graphical text editor input box, the duration between when the text is inputted and displayed on the displayed form will vary from computer to computer although it will be very near real time.

In addition, by virtue of such a method user may change the background color and or the size of the display forms to suite their need;

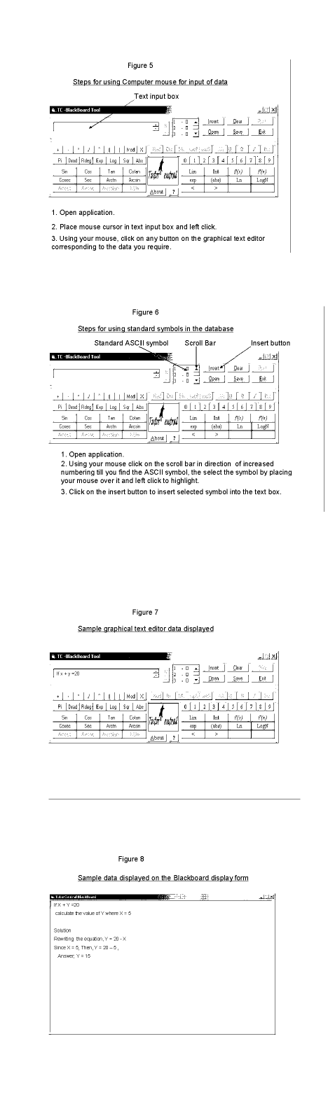

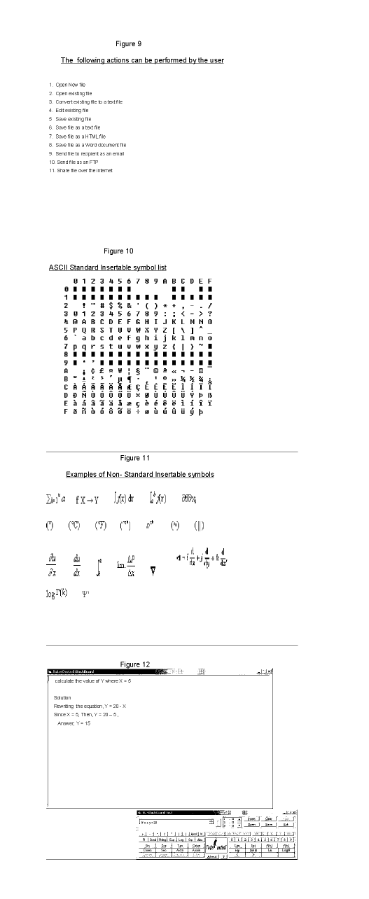

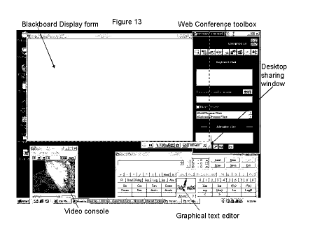

FIGS. 4, 5, 6 and 7 shows an illustrative configuration of the graphical user interface of the present invention.

What is claimed is:

1. A method for creating a computer-based blackboard for creating and displaying document containing text, and symbols by allowing input of data, editing such data, saving such data and retrieving saved data in either HTML, Text, XML and Word Doc.

2. A method according to claim 1 wherein said object comprises of a graphical text editor form and a display form.

3. A method according to claim 1 wherein said object is created on a data processing apparatus offline from a server.

4. A method according to claim 2 wherein a graphic user interface on a visual display unit exist.

5. A method according to claim 2, wherein an input box accepts text and graphical symbols.

6. A method according to claim 5, wherein data is entered using either keyboard or mouse or a combination of both.

7. A method according to claim 6, wherein data can be edited for deleting, font size change, font color, font bold, font italized, font subscripted and font indented.

8. A method according to claim 1, wherein data is transferred from graphical text editor form to the display form in near real time.

9. A method according to claim 8, wherein data transferred to the display, preserves all attribute and property of the incoming data from graphical text editor.

10. A method according to claim 1, wherein the data processed and display is either text standard ASCII symbols and or non-standard mathematical symbols.

11. A method according to claim 1, wherein the displayed data on the display refreshed and updated using the computer system timer.

12. A method according to claim 1, wherein said edited data is stored in a client-side machine, a file server, a removable data storage media, or shared through a server.

13. A method according to claim 1 wherein said display, can have its background color changed to primary or secondary colors for easier viewing or users preference.

14. A system for creating a computer-based blackboard for creating, editing and displaying document containing text and symbols for online web tutoring and application sharing.

15. A system according to claim 14 wherein said object comprises of a graphical text editor form and a display form.

16. A system according to claim 14 wherein said object is created on a data processing apparatus offline from a server.

17. A system according to claim 15, wherein said display form is used for online tutoring, said display form is captured by the Web Conferencing Software Desktop Capture Form.

18. A system according to claim 15, wherein said object can be shared across the web using a web conferencing software document sharing utility, said object can be stored in either client-side machine, a file server.
